(19) United States
(12) Patent Application Publication
(10) Pub. No.: US 2007/0265389 A1
(43) Pub. Date: Nov. 15, 2007

(54) Aqueous dispersions with bimodal particle size distribution

(76) Inventors: Sebastian Dorr, Dusseldorf (DE); Jan Mazanek, Koln (DE); Harald Blum, Leverkusen (DE); Heino Muller, Leverkusen (DE)

Correspondence Address: BAYER MATERIAL SCIENCE LLC, 100 BAYER ROAD, PITTSBURGH, PA, 15205, US

(21) Appl. No.: 11/800,118

(22) Filed: May 4, 2007

(30) Foreign Application Priority Data
May 9, 2006 (DE) 102006021728.4

(51) Int. Cl. C08G 18/08

(52) U.S. Cl. 524/591

(57) ABSTRACT

The invention relates to aqueous, self-crosslinking one-component (1K) PU dispersions having both a coarse fraction and a fine fraction, to a process for preparing them and to their use for producing high-solids baking varnishes.

### CROSS-REFERENCE TO RELATED APPLICATIONS

The present application claims the right of priority under 35 U.S.C. §119 (a)-(d) of German Patent Application Number 10 2006 021 728.4, filed May 9, 2006.

### BACKGROUND OF THE INVENTION

The invention relates to aqueous, self-crosslinking one-component (1K) PUR dispersions having both a coarse fraction and a fine fraction, to a process for preparing them and to their use for producing high-solids baking varnishes.

Substrates are increasingly being coated using aqueous binders, especially polyurethane-polyurea (PUR) dispersions. The preparation of aqueous PUR dispersions is known.

Unlike many other aqueous binder classes, PUR dispersions are distinguished in particular by a high level of resistance to chemicals and water, a high mechanical robustness, and a high tensile strength and extensibility. These requirements are largely met by polyurethane-polyurea dispersions. The systems are self-emulsifying as a result of hydrophilic groups, can be dispersed in water without assistance from external emulsifiers, and possess monomodal particle size distributions. In order to keep the viscosity of these dispersions within an acceptable range, they are typically commercially available with solids contents of between 30% and 45% by weight of solids fraction.

Recent years have seen further improvements made to the one-component (1K) baking varnishes employed, as for example, in EP-A 0 576 952, which describes combinations of water-soluble or water-dispersible polyhydroxy compounds with water-soluble or dispersible blocked polyisocyanates. Likewise, DE-A 199 30 555, discloses combinations of a water-dispersible, hydroxyl-functional binder component-containing urethane groups, a binder component-containing blocked isocyanate groups which is prepared in a multi-stage process over two prepolymerization steps, an amino resin, and further components. A disadvantage of these one-component systems is that the components prepared beforehand require an additional mixing step. The solids fractions achieved in the systems described, however, are generally well below 50%. This is a disadvantage with respect to the costs associated, for example, with transport and storage. Moreover, the further formulation of paint mixtures is restricted if the solids obtained is not high enough.

A modern, aqueous coating material is required to have a very high solids content. One reason is energy savings—for example, through reduced transport costs and the lower heat requirement for the evaporation of the water when such binders are cured; on the other hand, a very high solids content generally makes it possible to achieve more favorable application properties and/or film properties, such as higher achievable film thicknesses.

Dry film thicknesses of 50 to 70 μm are generally difficult to achieve with aqueous binders, since at such film thicknesses, which are relatively high for aqueous binders, there is a strong propensity towards the formation of pops, craters and other film defects. These defects are typically reduced or eliminated by addition of volatile high boilers, organic auxiliary solvents or similar adjuvants. On the other hand, however, this involves loosing part of the environmental friendliness of the aqueous binders.

Many of the high-solids PUR dispersions available commercially at present fail to satisfy the requirements. They are generally stabilized using large quantities of external emulsifiers, and possess broadly distributed, monomodal particle size distributions and high average particle sizes. As a result they can often be protected from sedimentation only via the addition of thickening agents. The profiles of properties of these high-solids dispersions are therefore well below the required level. There is, consequently, a need for improved dispersions with a high solids content.

WO-A 02/070615 presents bimodal aqueous polymer dispersions having two discrete particle size maxima. The examples exclusively describe the preparation of primary polyacrylate dispersions with a bimodal particle size distribution. The bimodality is produced in two stages; the resulting products are suitable in particular for coating paper.

WO-A 03/064534 describes the preparation of bimodal polyurethane dispersions based on two differently hydrophilicized polyurethane dispersions. The hydrophilic, fine-particle dispersion is mixed with the more hydrophobic, coarse-particle dispersion and subsequently the solids of the resulting bimodal dispersion is raised by removing part of the water under vacuum. Disadvantages of this described process are that it is very inconvenient and on the industrial scale entails high costs.

The dispersions of the prior art therefore do not fulfil all of the requirements of users, particularly not in respect of the solids content and of simplicity of preparation.

It is an object of the present invention, therefore, to provide a high-solids, aqueous, self-crosslinking 1K PUR dispersion which, with acceptable viscosities, is adjustable to high solids fractions and which, in coating applications, exhibit good properties with respect to film hardness, solvent resistance and film optical qualities. A further object is to provide a process for preparing such dispersions, allowing them to be prepared with simplicity.

It has now been found that a dispersion comprising as a coarse fraction [G] polyurethane-polyurea particles and as a fine fraction [F] crosslinker particles in a bimodal particle size distribution meets the requirements specified above.

### SUMMARY OF THE INVENTION

The present invention accordingly provides aqueous, self-crosslinking one-component (1K) polyurethane dispersions having a bimodal particle size distribution, which have two separate maxima, the fine fraction [F] of the crosslinker particles lying in the range from 1 to 100 nm, and the coarse fraction [G] of the polyurethane-polyurea particles lying in the range from 10 to 400 nm, and the weight ratio between the fine fraction and the coarse fraction lying between 0.5/99.5 and 10/90.

### DETAILED DESCRIPTION OF THE PREFERRED EMBODIMENTS

The fine fraction [F] of the crosslinker particles preferably have particle sizes lying in the range from 2 to 70 nm, more preferably 5 to 50 nm. The coarse fraction [G] of the polyurethane-polyurea particles preferably has particle sizes in the range of 15 to 250 nm and more preferably 15 to 200 nm. The weight ratio between the fine fraction and the coarse fraction is preferably 2/98 and 8/92, more preferably 3/97 and 6/94.

The dispersions of the invention have a solids content of 40% to 70% by weight, preferably of 45% to 65% by weight, more preferably of 50% to 60% by weight, the viscosity of the dispersion lying between 50 and 20000 mPas, preferably between 100 and 10000 mPas, more preferably between 2000 and 7000 mPas (23° C.).

Suitable crosslinker particles representing the fine fraction [F] of the dispersion of the invention are hydrophilicized polyisocyanates. The aqueous dispersion or solution of the polyisocyanate particles are prepared by reacting
a) a polyisocyanate component,
b) 50 to 90 equivalent-%, based on the isocyanate-reactive groups, of a thermally eliminable blocking agent,
c) 10 to 45 equivalent-%, based on the isocyanate-reactive groups, of a hydroxycarboxylic acid as hydrophilicizing agent and
d) 0 to 15 equivalent-% based on the isocyanate-reactive groups, of an at least difunctional chain extender component,
   the carboxylic acid groups of the hydroxycarboxylic acid being neutralized with a base e) before, during or after the polyurethane polymer is dispersed in water.

The proportions of the reactants are preferably chosen such that the equivalent ratio of the isocyanate component a) to isocyanate-reactive groups of components b), c) and d) is 1:0.7 to 1:1.3.

It is possible to add a solvent such as N-methylpyrrolidone, N-ethylpyrrolidone, methoxypropyl acetate, acetone and/or methyl ethyl ketone, for example, to the mixture. After the end of the reaction and dispersing it is possible to remove volatile solvents such as acetone and/or methyl ethyl ketone by distillation. It is preferred to use N-methylpyrrolidone or N-ethylpyrrolidone.

Polyisocyanates used for this purpose in a) are the NCO-functional compounds known per se to the skilled person, with a functionality of ≧(greater than or equal to) 2. These are typically aliphatic, cycloaliphatic, araliphatic and/or aromatic di- or triisocyanates and also their higher molecular mass derivatives containing urethane, allophanate, biurete, uretdione and/or isocyanurate groups, having two or more free NCO groups.

Preferred di- or polyisocyanates are tetramethylene diisocyanate, cyclohexane 1,3- and 1,4-diisocyanate, hexamethylene diisocyanate (HDI), 1-isocyanato-3,3,5-trimethyl-5-isocyanatomethylcyclohexane (isophorone diisocyanate, IPDI), methylenebis(4-isocyanatocyclohexane), tetramethylxylylene diisocyanate (TMXDI), triisocyanatononane, tolylene diisocyanate (TDI), diphenylmethane 2,4′- and/or 4,4′-diisocyanate (MDI), triphenylmethane 4,4′-diisocyanate, naphthylene 1,5-diisocyanate, 4-isocyanatomethyloctane 1,8-diisocyanate (nonane triisocyanate, triisocyanatononane, TIN) and/or 1,6,11-undecane triisocyanate, and also any desired mixtures thereof.

Suitable polyisocyanates typically have isocyanate contents of 0.5% to 50% by weight, preferably of 3% to 30% by weight, more preferably of 5% to 25% by weight.

Preferred polyisocyanates a) for preparing the hydrophilicized polyisocyanate particles (I) correspond to the type specified above and contain biuret, iminooxadiazinedione, isocyanurate and/or uretdione groups and are based preferably on hexamethylene diisocyanate, isophorone diisocyanate and/or 4,4′-diisocyanatodicyclohexylmethane.

Examples of suitable blocking agents b) are ε-caprolactam, diethyl malonate, ethyl acetoacetate, oximes such as butanone oxime, for example, amines such as N,N-diisopropylamine or N,N-tert-butylbenzylamine, for example, ester amines such as alkylalanine esters, dimethylpyrazole, triazole, and mixtures, and also, optionally further blocking agents. Preference is given to butanone oxime, diisopropylamine, 3,5-dimethylpyrazole, N-tert-butylbenzylamine and/or mixtures thereof, particular preference to butanone oxime.

Examples of hydroxycarboxylic acids c) are mono- and dihydroxycarboxylic acids, such as 2-hydroxyacetic acid, 3-hydroxypropanoic acid, 12-hydroxy-9-octadecanoic acid (ricinoleic acid), hydroxypivalic acid, lactic acid, dimethylolbutyric acid and/or dimethylolpropionic acid. Preference is given to hydroxypivalic acid, lactic acid and/or dimethylolpropionic acid, particular preference to hydroxypivalic acid.

In addition to the hydrophilicization by at least one hydroxycarboxylic acid it is possible as well to use suitable nonionically hydrophilicizing compounds these are, for example, polyoxyalkylene ethers which contain at least one hydroxyl or amino group. These polyethers include a fraction of 30% to 100% by weight of units derived from ethylene oxide. Suitably included are polyethers of linear construction with a functionality of between 1 and 3, and also branched polyethers.

Examples of suitable nonionically hydrophilicizing compounds also include monohydric polyalkylene oxide polyether alcohols containing on average 5 to 70, preferably 7 to 55, ethylene oxide units per molecule, of the kind accessible in a manner known per se by alkoxylation of suitable starter molecules.

The polyalkylene oxide polyether alcohols are either simple polyethylene oxide polyethers or mixed polyalkylene oxide polyethers at least 30 mol % and preferably at least 40 mol % of whose alkylene oxide units are composed of ethylene oxide units. Preferred nonionic compounds are monofunctional mixed polyalkylene oxide polyethers which contain at least 40 mol % ethylene oxide and not more than 60 mol % propylene oxide units.

Examples of suitable chain extender components d) include diols, triols and/or polyols. Examples are ethanediol, di-, tri-, tetraethylene glycol, 1,2-propanediol, di-, tri-, tetrapropylene glycol, 1,3-propanediol, butane-1,4-diol, butane-1,3-diol, butane-2,3-diol, pentane-1,5-diol, hexane-1,6-diol, 2,2-dimethyl-1,3-propanediol, 1,4-dihydroxycyclohexane, 1,4-dimethylolcyclohexane, octane-1,8-diol, decane-1,10-diol, dodecane-1,12-diol, trimethylolpropane, castor oil, glycerol and/or mixtures of the products stated. Ethoxylated and/or propoxylated diols, triols and/or polyols such as, for example, ethoxylated and/or propoxylated trimethylolpropane, glycerol and/or hexane-1,6-diol can also be used.

In addition it is possible to use di-, tri- and/or polyamines having primary and/or secondary amino groups. Examples are ethylenediamine, 1,3-propylenediamine, 1,6-hexamethylenediamine, isophoronediamine, 4,4′-diaminodicyclohexylmethane or hydrazine.

Mixtures of amines and alcohols are also possible, as are compounds with mixed functionality, such as N-methylethanolamine or N-methylisopropanolamine, 1-aminopropanol or diethanolamine, for example. Likewise possible are compounds containing thiol groups, such as 1,2-hydroxyethanethiol or 1-aminopropanethiol, for example.

Example of neutralizing agents used in e) are basic compounds such as sodium hydroxide, potassium hydroxide, triethylamine, N,N-dimethylaminoethanol, dimethylcyclohexylamine, triethanolamine, methyldiethanolamine, diisopropanolamine, ethyldiisopropylamine, diisopropylcyclohexylamine, N-methylmorpholine, 2-amino-2-methyl-1-propanol, ammonia or mixtures thereof. Preferred neutralizing agents are tertiary amines such as triethylamine, diisopropylhexylamine and N,N-dimethylethanolamine; N,N-dimethylethanolamine is particularly preferred.

The amount of neutralizing agent used is generally calculated such that the degree of neutralization of the carboxylic acid groups present in the polyisocyanate particles (molar ratio of amine/hydroxide employed to acid groups present) is at least 40%, preferably 70% to 130%, more preferably 90% to 110%. The neutralization may take place before, during or after the dispersing or dissolving step. Preference is nevertheless given to neutralization before the addition of water.

It is likewise possible to add catalysts to the reaction mixture. Examples of suitable catalysts are tertiary amines, tin compounds, zinc compounds, bismuth compounds or basic salts. Those preferred are dibutyltin dilaurate and dibutyltin octoate.

The polyurethane-polyurea particles of the coarse fraction [G] are preferably polyesterpolyurethanes containing carboxyl and hydroxyl groups. They are prepared by a process which involves preparing in a first step (I)
an ionically hydrophilicized prepolymer containing hydroxyl or isocyanate end groups by reacting
one or more polyisocyanates (A1) having an NCO functionality of ≧2,
at least one hydroxycarboxylic acid (C′), preferably dimethylolpropionic acid,
optionally a further polyol component (B1) having a hydroxyl group functionality of ≧2 and a molecular weight Mₙ of 62 to 500 Da, preferably 62 to 400 Da, more preferably 62 to 300 Da,
   reacting the product of step (I) in a second step (II) with
one or more polyol components (B2) having a hydroxyl group functionality of ≧1,
at least one polyol component (B3) having an average hydroxyl group functionality of ≧2 and a molecular weight Mₙ of 500 to 5000 Da, preferably 500 to 3000 Da, more preferably 500 to 2000 Da,
one or more thermally eliminable blocking agents (Y), and
optionally polyisocyanates (A1) having an NCO functionality of ≧2 and then converting this prepolymer by reaction (III) with
at least one hydroxycarboxylic acid (C″), preferably hydroxypivalic acid, and
polyisocyanates (A1) having an NCO functionality of ≧2,
   into a polyurethane polymer which is free from isocyanate groups but has hydroxyl group functionality and which for full or partial neutralization is admixed with a neutralizing agent (N).

In the process the ratio of the isocyanate groups, including uretdione groups, to all groups that are reactive towards isocyanate groups should be maintained at from 0.5 to 5.0:1, preferably 0.6 to 2.0:1, more preferably 0.8 to 1.5:1.

Suitable polyisocyanate components (A1) are aliphatic, cycloaliphatic, araliphatic and/or aromatic isocyanates having an average functionality of 2 to 5, preferably 2, and having an isocyanate content of 0.5% to 60% by weight, preferably of 3% to 40% by weight, more preferably of 5% to 30% by weight, such as tetramethylene diisocyanate, cyclohexane 1,3- and 1,4-diisocyanate, hexamethylene diisocyanate (HDI), 1-isocyanato-3,3,5-trimethyl-5-isocyanatomethylcyclohexane (isophorone diisocyanate IPDI), methylenebis(4-isocyanatocyclohexane), tetramethylxylylene diisocyanate (TMXDI), triisocyanatononane, tolylene diisocyanate (TDI), diphenylmethane 2,4′- and/or 4,4′-diisocyanate (MDI), triphenylmethane 4,4′-diisocyanate or naphthylene 1,5-diisocyanate, and also any desired mixtures of such isocyanates. Preference is given to isophorone diisocyanate, bis(4,4-isocyanatocyclohexylmethane) or hexamethylene diisocyanate.

Additionally suitable are low molecular weight polyisocyanates containing urethane groups, of the kind obtainable by reacting IPDI or TDI, employed in excess, with simple polyhydric alcohols of the molecular weight range 62 to 300, in particular with trimethylolpropane or glycerol.

Suitable polyisocyanates (A1) are, furthermore, the known prepolymers containing terminal isocyanate groups, of the kind accessible in particular through reaction of the abovementioned simple polyisocyanates, especially diisocyanates, with substoichiometric amounts of organic compounds having at least two isocyanate-reactive functional groups. In these known prepolymers the ratio of isocyanate groups to NCO-reactive hydrogen atoms is 1.05:1 to 10:1, preferably 1.5:1 to 4:1, the hydrogen atoms originating preferably from hydroxyl groups. The nature and proportions of the starting materials used in preparing NCO prepolymers are chosen such that the NCO prepolymers preferably have an average NCO functionality of 2 to 3 and a number-average molar mass of 500 to 10000, preferably 800 to 4000.

The polyol component (B1) comprises difunctional to hexafunctional polyol components of molecular weight Mₙ from 62 to 500 Da, preferably 62 to 400 Da, more preferably 62 to 300 Da. Examples of preferred polyol components (B1) are 1,4- and/or 1,3-butanediol, 1,6-hexanediol, 2,2,4-trimethyl-1,3-pentanediol, trimethylolpropane, polyester polyols and/or polyether polyols of average molar weight Mₙ less than or equal to 500 Da.

Suitable acid-functional compounds (C′)/(C″) are hydroxyl-functional carboxylic acids, preferably mono- and dihydroxy carboxylic acids, such as 2-hydroxyacetic acid, 3-hydroxypropanoic acid or 12-hydroxy-9-octadecanoic acid (ricinoleic acid), hydroxypivalic acid, lactic acid, dimethylolbutyric acid and/or dimethylolpropionic acid. Preference is given to hydroxypivalic acid, lactic acid and/or dimethylolpropionic acid. (C′) is preferably dimethylolpropionic acid, (C″) is preferably hydroxypivalic acid.

If component (B1) is used fractionally in step (I), its fraction, however, is not more than 50% by weight, based on the sum of components (C) and (B1). It is preferred to use exclusively component (C) in step (I).

The polyol component (B2) is selected from the group of
b1) dihydric to hexahydric alcohols having average molar weights Mₙ of 62 to 300 Da, preferably of 62 to 182 Da, more preferably of 62 to 118 Da,
b2) linear, difunctional polyols having average molar weights Mₙ of 350 to 4000 Da, preferably of 350 to 2000 Da, more preferably of 350 to 1000 Da,
b3) monofunctional linear polyethers having average molar weights Mₙ of 350 to 2500 Da, preferably of 500 to 1000 Da.

Suitable polyol components (b1) are dihydric to hexahydric alcohols and/or mixtures thereof that contain no ester groups. Typical examples are ethane-1,2-diol, propane-1,2- and -1,3-diol, butane-1,4-, -1,2-diol or 2,3-hexane-1,6-diol, 1,4-dihydroxycyclohexane, glycerol, trimethylolethane, trimethylolpropane, pentaerythritol and sorbitol. As component b1) it is of course also possible to use alcohols containing ionic groups or groups which can be converted into ionic groups. Preference is given for example to 1,4- or 1,3-butane diol, 1,6-hexane diol or trimethylolpropane and also mixtures thereof.

Suitable linear difunctional polyols (b2) are selected from the group of polyethers, polyesters and/or polycarbonates. The polyol component (b2) preferably comprises at least one ester group-containing diol of molecular weight Mₙ from 350 to 4000 Da, preferably from 350 to 2000 Da, more preferably from 350 to 1000 Da. The molecular weight in question is the average molecular weight as can be calculated from the hydroxyl number. The esterdiols are generally mixtures which may also include minor amounts of individual constituents having a molecular weight situated above or below these limits. The polyesterdiols in question are those which are known per se and are constructed from diols and dicarboxylic acids.

Examples of suitable diols are 1,4-dimethylolcyclohexane, 1,4- or 1,3-butanediol, 1,6-hexanediol, neopentyl glycol, 2,2,4-trimethyl-1,3-pentanediol, trimethylolpropane and pentaerythritol and/or mixtures of such diols. Examples of suitable dicarboxylic acids are aromatic dicarboxylic acids such as phthalic acid, isophthalic acid and terephthalic acid, cycloaliphatic dicarboxylic acids such as hexahydrophthalic acid, tetrahydrophthalic acid, endomethylenetetrahydrophthalic acid and their anhydrides, for example, and aliphatic dicarboxylic acids, which are used with preference, such as succinic acid, glutaric acid, adipic acid, suberic acid, azelaic acid and sebacic acid or their anhydrides.

Polyesterdiols based on adipic acid, phthalic acid, isophthalic acid and tetrahydrophthalic acid are used preferably as component (b2). Preferred diols used are, for example, 1,4- or 1,3-butanediol, 1,6-hexanediol or trimethylolpropane and also mixtures thereof.

Particular preference is given, however, to using, as component (b2), polycaprolactonediols of average molecular weight from 350 to 4000 Da, preferably from 350 to 2000 Da, more preferably from 350 to 1000 Da, said polycaprolactonediols having been prepared in a manner known per se from a diol or diol mixture of the type exemplified above, as starter, and from ε-caprolactone. The preferred starter molecule in this case is 1,6-hexanediol. Very particular preference is given to those polycaprolactonediols which have been prepared by polymerizing ε-caprolactone using 1,6-hexanediol as starter.

As linear polyol component (b2) it is also possible to use (co)polyethers of ethylene oxide, propylene oxide and/or tetrahydrofuran. Preference is given to polyethers having an average molar weight Mₙ of 500 to 2000 Da, such as polyethylene oxides or polytetrahydrofurandiols, for example.

Also suitable as (b2) are hydroxyl-containing polycarbonates, preferably of average molar weight Mₙ from 400 to 4000 Da, preferably 400 to 2000 Da, such as hexanediol polycarbonate, for example, and also polyestercarbonates.

Suitable monofunctional linear polyethers (b3) are for example (co)polyethers of ethylene oxide and/or propylene oxide. Preference is given to polyalkylene oxide polyethers of average molar weight Mₙ from 350 to 2500 Da which are prepared starting from monoalcohol and have at least 70% ethylene oxide units. Particularly preferred are (co)polymers with more than 75% ethylene oxide units and a molar weight Mₙ of 350 to 2500 Da, preferably of 500 to 1000 Da. Starter molecules used in preparing these polyethers are preferably monofunctional alcohols having 1 to 6 carbon atoms.

Suitable polyols (B3) are branched polyols having an OH functionality of greater than or equal to 2, and having average molar weights of 500 to 5000 Da, preferably of 500 to 3000 Da, more preferably of 500 to 2000 Da.

Preferred polyols (B3) are, for example, polyethers with an average molar weight of 300 to 2000 Da and an average functionality of 2.5 to 40H groups/molecule. Likewise preferred are polyesters with an average OH functionality of 2.5 to 4.0. Suitable diols and dicarboxylic acids for the polyesters are those specified under component (b2), but they additionally include trifunctional to hexafunctional short-chain polyols, such as trimethylolpropane, pentaerythritol or sorbitol, for example. It is preferred to use polyesterpolyols based on adipic acid, phthalic acid, isophthalic acid and tetrahydrophthalic acid and also butane-1,4-diol and hexane-1,6-diol.

Likewise suitable as component (B3) are (co)polyethers of ethylene oxide, propylene oxide and/or tetrahydrofuran with an average functionality of greater than or equal to 2, and also branched polycarbonates.

The process of the invention ought to be carried out such that in the reaction of components (A) and (B1), in accordance with the theoretical stoichiometric equation, there is very little unreacted, excess components (A) and/or (B1) present.

Examples of suitable blocking agents (Y) are ε-caprolactam, diethyl malonate, ethyl acetoacetate, oximes such as butanone oxime, for example, amines such as N,N-diisopropylamine or N,N-tert-butylbenzylamine, for example, ester amines such as alkylalanine esters, dimethylpyrazole, triazole, and mixtures, and also, optionally further blocking agents. Preference is given to butanone oxime, diisopropylamine, 3,5-dimethylpyrazole, N-tert-butylbenzylamine and mixtures thereof, particular preference to butanone oxime.

A preferred process for preparing the polyurethane-polyurea particles of the coarse fraction [G] is one in which in step (I) the components are reacted to form an NCO-functional prepolymer.

To regulate the viscosity it is also possible optionally to add solvents to the reaction mixture when preparing the polyesterpolyurethanes. Those suitable include all known paint solvents, such as N-methylpyrrolidone, methoxypropyl acetate or xylene, for example. They are used preferably in amounts of 0% to 10% by weight, more preferably in 0% to 5% by weight. The solvent is preferably added during the polymerization.

It is also possible to add a (partly) water-miscible solvent such as acetone or methyl ethyl ketone to the reaction mixture. After the end of the reaction, water is added to the reaction mixture and the solvent is removed by distillation. This is also referred to as the acetone or slurry process. The advantage of this procedure lies in the low solvent fraction in the completed dispersion.

It is likewise possible to add catalysts to the reaction mixture. Preferred catalysts are metal catalysts such as dibutyltin dilaurate and dibutyltin octoate.

Likewise provided by the present invention is a process for preparing the aqueous 1K polyurethane dispersions of the invention, characterized in that the polyurethane-polyurea particles of the coarse fraction [G] are dispersed with water and with the fine-particle dispersion [F], the weight ratio of water and fine-particle dispersion [F] lying between 1/1 and 1/20, preferably between 1/2 and 1/10.

In the process of the invention, the fine-particle dispersion [F] can be added before, during or after the addition of the remaining water. Also possible is the mixing of the fine-particle dispersion [F] with the water beforehand.

It is also possible first to prepare the coarse part and disperse it with water and then to add this dispersion to the prepolymer of the fine part. This procedure, however, is less preferred.

The preferred temperature range for the process of the invention lies between 10 and 90° C., preferably between 20 and 70° C.

At least 50%, preferably 80% to 120%, more preferably 95% to 105% of the carboxylic acid groups present in the polyurethane particles (II) are neutralized with suitable neutralizing agents and then dispersed with deionized water. The neutralization may take place before, during or after the dispersing or dissolving step. Neutralization before the water is added is preferred, though.

Suitable neutralizing agents (N) are, for example, triethylamine, dimethylaminoethanol, dimethylcyclohexylamine, triethanolamine, methyldiethanolamine, diisopropanolamine, diisopropylcyclohexylamine, N-methylmorpholine, 2-amino-2-methyl-1-propanol, ammonia or other customary neutralizing agents or neutralizing mixtures thereof. Preference is given to tertiary amines such as triethylamine, diisopropylhexylamine, for example, particular preference to dimethylethanolamine.

Likewise provided in the present invention are baking varnishes comprising the aqueous, self-crosslinking one-component (1K) polyurethane dispersions of the invention. Besides the particles of the fine and coarse fractions these varnishes may also comprise auxiliaries and adjuvants as well.

The auxiliaries and adjuvants used optionally include, for example, pigments, such as titanium dioxide pigments, iron oxide pigments, lead oxide pigments and zinc oxide pigments, for example, fillers such as alkaline earth metal silicates, for example, carbon black (which may also take on the function of a pigment), talc, graphite, organic dyes, flow control assistants, antifoams, UV absorbers, anti-settling agents, thickeners, wetting agents, antioxidants, antiskinning agents or crosslinking catalysts.

The invention also provides for the use of the dispersions of the invention for producing inks, paints, sealants or adhesives.

The aqueous one-component coating materials comprising the polyurethane dispersions of the invention can be applied in one or more coats to any desired heat-resistant substrates by any desired methods of coating technology, such as spraying, spreading, dipping, flowcoating, or using rollers and baths. The coating films generally have a dry film thickness of 0.01 to 0.3 mm.

Examples of suitable substrates include metal, plastic, wood or glass. The coating film is cured at 80 to 220° C., preferably at 130 to 260° C.

The aqueous one-component coating materials comprising the polyurethane dispersions of the invention are suitable with preference for producing coatings and paint systems on steel sheets, of the kind used, for example, for producing vehicle bodies, machines, panelling, drums or containers. Particular preference is given to the use of the aqueous one-component coating materials comprising the polyurethane dispersions of the invention for producing automotive surfacers and/or topcoat materials.

The examples which follow elucidate the invention more closely.

### EXAMPLES

Unless noted otherwise, all percentages are by weight.

Unless noted otherwise, all analytical measurements relate to temperatures from 23° C.

The reported viscosities were determined by means of rotational viscometry in accordance with DIN 53019 at 23° C. using a rotational viscometer from Anton Paar Germany GmbH, Ostfildem, Germany.

NCO contents were determined, unless expressly mentioned otherwise, volumetrically in accordance with DIN-EN ISO 11909.

The reported particle sizes were determined by means of laser correlation spectroscopy (instrument: Malvern Zetasizer 1000, Malvern Instra. Limited).

The solids contents were determined by heating a weighed sample at 120° C. At constant weight, the sample was weighed again to calculate the solids content.

The check for free NCO groups was carried out by means of IR spectroscopy (band at 2260 cm⁻¹).

Chemicals:

Desmodur® N 3300:

Isocyanurate based on hexamethylene diisocyanate, Bayer MaterialScience AG, Leverkusen, Germany.

Desmodur® Z 4470 M/X:

Aliphatic polyisocyanate based on isophorone diisocyanate, as a 70% strength solution in a mixture of methoxypropyl acetate and xylene (1/1), isocyanate content approximately 12%, Bayer MaterialScience AG, Leverkusen, Germany.

Additol® XW 395:

Flow control assistant/defoamer, UCB Chemicals, St. Louis, USA.

Surfynol® 104

Flow control assistant/defoamer, Air Products, Hattingen, Germany.

### Example 1

### Dispersion of Small Particles (Fine Fraction)

343.20 g of Desmodur® N 3300 (Bayer AG, Leverkusen) were mixed at 70° C. with 9.45 g of 1,6-hexanediol and after 5 minutes with a solution of 47.20 g of hydroxypivalic acid in 76.16 g of N-methylpyrrolidone (dropwise addition for 2 hours) and then the mixture was stirred at 70° C. until a constant NCO value of 9.62% (calc. 10.59%) was reached (about 30 minutes after adding the hydroxypivalic acid solution). Then 94.66 g of butanone oxime were added over the course of 30 minutes and stirring was continued at 70° C. until NCO groups were no longer detectable by IR spectroscopy (about 30 minutes). Subsequently 39.22 g of dimethylethanolamine were added, the mixture was stirred for 10 minutes, and then dispersion was carried out using 724.44 g of deionized water of 70° C. The dispersion was cooled to 50° C., stirred for an hour and left to cool to room temperature with stirring (about 4 hours).

The properties of the resulting dispersion were as follows:

| | |
|---|---|
| Solids content | 36.5% |
| pH | 9.45 |
| Viscosity (Haake rotational viscometer, 23° C.) | 418 mPas |
| Particle size (laser correlation spectroscopy, LCS) | 21 nm |

### Example 2

Comparative Example, More than 10% Fine Fraction (10.8% Small Particles)→no Increase in Solids

40.24 g of dimethylolpropionic acid were dissolved in 80.11 g of N-methylpyrrolidone and 44.21 g of isophorone diisocyanate are added to the solution at 85° C. with stirring. The mixture was stirred at 85° C. until NCO groups were no longer detectable by means of IR spectroscopy (about 8 hours). Then 161.24 g of isophorone diisocyanate, 210.00 g of a polyester of adipic acid and 1,6-hexanediol of average molar weight 840, 25.00 g of a monofunctional polyethylene glycol having an average molar weight of 500 (Pluriol 500, BASF AG, Ludwigshafen) and 108.00 g of Desmodur® Z 4470 M/X (Bayer AG, Leverkusen) were added and the mixture was stirred at 85° C. for 3 hours. The NCO value was 6.11% (calc. 6.28). Thereafter 43.56 g of butanone oxime and, after a further 10 minutes, 318.18 g (1.00 eq OH) of a polyester formed from adipic acid, isophthalic acid, trimethylolpropane, neopentyl glycol and propylene glycol were added. Stirring was continued at 85° C. until NCO groups were no longer detectable by IR spectroscopy (about 16 hours) and then a solution of 23.60 g of hydroxypivalic acid in 37.74 g of N-methylpyrrolidone was added and 144.00 g of Desmodur® Z 4470 M/X (Bayer AG, Leverkusen) were added. After about 3 hours NCO groups were no longer detectable by IR spectroscopy; at that point the mixture was cooled to 80° C. and then 44.57 g of dimethylethanolamine were added, and stirring carried out for 10 minutes. Dispersion is carried out using 331.58 g of the dispersion from Example 1 and then 784.04 g of deionized water of 50° C. The dispersion was cooled to 50° C., stirred for 1 hour and left to cool to room temperature with stirring (about 4 hours).

The properties of the resulting dispersion were as follows:

| | |
|---|---|
| Solids content | 47.8% |
| pH | 7.78 |
| Viscosity (Haake rotational viscometer, 23° C.) | 4480 mPas |
| Particle size (laser correlation spectroscopy, LCS) | 51 nm |

### Example 3

Inventive Dispersion, Less than 10% Fine Fraction (3.8% Small Particles)→Increase in Solids

40.24 g of dimethylolpropionic acid were dissolved in 80.11 g of N-methylpyrrolidone and 44.21 g of isophorone diisocyanate are added to the solution at 85° C. with stirring. The mixture was stirred at 85° C. until NCO groups were no longer detectable by means of IR spectroscopy (about 8 hours). Then 161.24 g of isophorone diisocyanate, 210.00 g of a polyester of adipic acid and 1,6-hexanediol of average molar weight 840, 25.00 g of a monofunctional polyethylene glycol having an average molar weight of 500 (Pluriol 500, BASF AG, Ludwigshafen) and 108.00 g of Desmodur® Z 4470 M/X (Bayer AG, Leverkusen) were added and the mixture was stirred at 85° C. for 3 hours. The NCO value was 6.11% (calc. 6.28). Thereafter 60.98 g of butanone oxime and, after a further 10 minutes, 318.18 g (1.00 eq OH) of a polyester formed from adipic acid, isophthalic acid, trimethylolpropane, neopentyl glycol and propylene glycol were added. Stirring was continued at 85° C. until NCO groups were no longer detectable by IR spectroscopy (about 16 hours) and then a solution of 23.60 g of hydroxypivalic acid in 37.74 g of N-methylpyrrolidone was added and 144.00 g of Desmodur® Z 4470 M/X (Bayer AG, Leverkusen) were added. After about 3 hours NCO groups were no longer detectable by IR spectroscopy; at that point the mixture was cooled to 80° C. and then 44.57 g of dimethylethanolamine were added, and stirring carried out for 10 minutes. Dispersion is carried out using 110.53 g of the dispersion from Example 1 and then 668.77 g of deionized water of 50° C. The dispersion was cooled to 50° C., stirred for 1 hour and left to cool to room temperature with stirring (about 4 hours).

The properties of the resulting dispersion were as follows:

| | |
|---|---|
| Solids content | 54.66% |
| pH value | 8.20 |
| Viscosity (Haake rotational viscometer, 23° C.) | 4460 mPas |
| Particle size (laser correlation spectroscopy, LCS) | 94 nm |

### Example 4

Inventive Dispersion, Less than 10% Fine Fraction (4.2% Small Particles)→Increase in Solids

The procedure described in Example 3 was repeated but carrying out dispersion with 122.80 g of the dispersion from Example 1 and 665.43 g of deionized water of 50° C.

The properties of the resulting dispersion were as follows:

| | |
|---|---|
| Solids content | 57.20% |
| pH | 8.14 |
| Viscosity (Haake rotational viscometer, 23° C.) | 5610 mPas |
| Particle size (laser correlation spectroscopy, LCS) | 83 nm |

### Example 5

Inventive Dispersion, 4.2% Small Particles, Adjusted to a Lower Viscosity to Determine the Resultant Solids

The procedure described in Example 5 was repeated, but after dispersing and the subsequent stirring additional deionized water was added successively until a viscosity of 1100-1200 mPas was reached.

The properties of the resulting dispersion were as follows:

| | |
|---|---|
| Solids content | 51.80% |
| pH | 8.15 |
| Viscosity (Haake rotational viscometer, 23° C.) | 1180 mPas |
| Particle size (laser correlation spectroscopy, LCS) | 82 nm |

### Example 6

Comparative Example, Monomodal Dispersion with Same Blocked Isocyanate Group Content, Leads to Lower Solids

40.24 g of dimethylolpropionic acid were dissolved in 80.11 g of N-methylpyrrolidone and 44.21 g of isophorone diisocyanate are added to the solution at 85° C. with stirring. The mixture was stirred at 85° C. until NCO groups were no longer detectable by means of IR spectroscopy (about 8 hours). Then 161.24 g of isophorone diisocyanate, 210.00 g of a polyester of adipic acid and 1,6-hexanediol of average molar weight 840, 25.00 g of a monofunctional polyethylene glycol having an average molar weight of 500 (Pluriol 500, BASF AG, Ludwigshafen) and 108.00 g of Desmodur® Z 4470 M/X (Bayer AG, Leverkusen) were added and the mixture was stirred at 85° C. for 3 hours. The NCO value was 6.11% (calc. 6.28). Thereafter 69.70 g of butanone oxime and, after a further 10 minutes, 318.18 g (1.00 eq OH) of a polyester formed from adipic acid, isophthalic acid, trimethylolpropane, neopentyl glycol and propylene glycol were added. Stirring was continued at 85° C. until NCO groups were no longer detectable by IR spectroscopy (about 16 hours) and then a solution of 23.60 g of hydroxypivalic acid in 37.74 g of N-methylpyrrolidone was added and 144.00 g of Desmodur® Z 4470 M/X (Bayer AG, Leverkusen) were added. After about 3 hours NCO groups were no longer detectable by IR spectroscopy; at that point the mixture was cooled to 80° C. and then 44.57 g of dimethylethanolamine were added, followed by stirring for 10 minutes, and then dispersion was carried out with 903.25 g of deionized water of 50° C. The dispersion was cooled to 50° C., stirred for 1 hour and left to cool to room temperature with stirring (about 4 hours).

The properties of the resulting dispersion were as follows:

| | |
|---|---|
| Solids content | 48.64% |
| Viscosity (Haake rotational viscometer, 23° C.) | 1120 mPas |
| Particle size (laser correlation spectroscopy, LCS) | 84 nm |

It was found that when a viscosity of 1100-1200 mPas is set the solids content achieved is relatively low, below 50%. This is below the solids content of approximately 52% that is achieved under similar conditions with a bimodally distributed dispersion (cf. Example 5).

### Example 7

Comparative Example, Similar to Example 6, But Attempt to Set a Solids Content of 55% Using a Non-Inventive, Monomodal Dispersion with Same Blocked Isocyanate Group Content

40.24 g of dimethylolpropionic acid were dissolved in 80.11 g of N-methylpyrrolidone and 44.21 g of isophorone diisocyanate are added to the solution at 85° C. with stirring. The mixture was stirred at 85° C. until NCO groups were no longer detectable by means of IR spectroscopy (about 8 hours). Then 161.24 g of isophorone diisocyanate, 210.00 g of a polyester of adipic acid and 1,6-hexanediol of average molar weight 840, 25.00 g of a monofunctional polyethylene glycol having an average molar weight of 500 (Pluriol 500, BASF AG, Ludwigshafen) and 108.00 g of Desmodur® Z 4470 M/X (Bayer AG, Leverkusen) were added and the mixture was stirred at 85° C. for 3 hours. The NCO value was 6.11% (calc. 6.28). Thereafter 69.70 g of butanone oxime and, after a further 10 minutes, 318.18 g (1.00 eq OH) of a polyester formed from adipic acid, isophthalic acid, trimethylolpropane, neopentyl glycol and propylene glycol were added. Stirring was continued at 85° C. until NCO groups were no longer detectable by IR spectroscopy (about 16 hours) and then a solution of 23.60 g of hydroxypivalic acid in 37.74 g of N-methylpyrrolidone was added and 144.00 g of Desmodur® Z 4470 M/X (Bayer AG, Leverkusen) were added. After about 3 hours NCO groups were no longer detectable by IR spectroscopy; at that point the mixture was cooled to 80° C. and then 44.57 g of dimethylethanolamine were added, followed by stirring for 10 minutes, and then dispersion was carried out with 636.24 g of deionized water of 50° C. This corresponds to the setting of a solids content of 55%.

The highly viscous mixture was cooled to 50° C. Stirring at 50° C. was no longer possible, since as a result of the high viscosity the mixture rose up on the stirrer. It was not possible to set a solids content of approximately 55% with the monomodally distributed dispersion. With the inventive bimodally distributed dispersions in Examples 3 and 4, however, this was possible.

The performance properties of the dispersions of the invention are apparent from Table 1.

Clear varnishes with the composition below were prepared. From the clear varnishes, films were produced, dried at room temperature for 10 minutes and then baked at 140° C. or 160° C. for 30 minutes. The films obtained were assessed from a performance standpoint.

The pendulum hardnesses were measured by the method of König in accordance with DIN 53157.

The bleed fastnesses were assessed after a 1-minute exposure time to each solvent, the sequence of the solvents being as follows: xylene/methoxypropyl acetate/ethyl acetate/acetone; assessment: 0 very good to 5 poor.

The objective is to obtain a varnish having very high solids with a flow time (viscosity measure) of around 40 seconds. After baking, the pendulum hardness ought to be 80-130 seconds and the bleed fastness with respect to all solvents ought to be assessed with a rating of better than 5. The appearance of the coating film on visual inspection ought to be classed as OK.

TABLE 1

| | Varnish Example No. | | | |
|---|---|---|---|---|
| | 8 | 9* | 10* | 11 |
| | Dispersion from Example No. | | | |
| | 2 | 3 | 4 | 6 |
| Initial product masses [g] | 150.0 | 153.0 | 150.0 | 150.0 |
| Additol XW 395, asf. [g] | 1.3 | 1.5 | 0.9⁴ | 1.3 |
| Surfynol 104, 50% in NMP [g] | 1.3 | 1.5 | | 1.3 |
| N,N-Dimethylethanolamine, | — | 0.8 | 3.9 | 2.5 |
| 10% in water [g] | | | | |
| Distilled water [g] | 21.0 | 24.0 | 28.0 | 16.5 |
| Total [g] | 173.6 | 180.8 | 182.8 | 171.6 |
| Solids [%] | 41.3 | 45.4 | 46.9 | 42.5 |
| Flow time ISO 5 mm [s] | 41 | 37 | 39 | 39 |
| pH | 8.3 | 8.3 | 8.3 | 8.3 |
| Baking conditions: | | | | |
| 10 min. RT + 30 min. 140° C. | | | | |
| Pendulum hardness [s] | 94 | 88 | 97 | 191 |
| Bleed fastness 1 min. (0-5) | 4344 | 4444 | 4344 | 4344 |
| Coating film appearance⁽¹⁾ | OK | OK | OK | OK |
| Baking conditions: | | | | |
| 10 min. RT + 30 min. 160° C. | | | | |
| Pendulum hardness [s] | 127 | 119 | 111 | 196 |
| Bleed fastness 1 min. (0-5) | 2244 | 3244 | 4344 | 2244 |
| Coating film appearance⁽¹⁾ | OK | OK | OK | OK |

asf = as-supplied form
⁽¹⁾OK = satisfactory, defect-free
⁽²⁾Setting of viscosity not possible, owing to dilatancy
⁽³⁾Measurement not possible owing to coalescence of the film
⁽⁴⁾Instead of Additol XW 395, Byk 347 (Byk-Chemie, Wesel, DE) was used.
(*inventive)

On the basis of the varnish formulations it is apparent that with the inventive dispersions 3 and 4 a substantially higher solids in the completed varnish formulation is achieved. The objectives of the properties with respect to the baked coating were likewise achievable.

From the non-inventive dispersions 2 (fraction of small particles in the dispersion >10%) and 6 (monomodal distribution of the particles in the dispersion) it was possible to achieve only lower solids fractions for a comparable varnish formulation viscosity.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. An aqueous, self-crosslinking one-component (1K) polyurethane dispersion having a bimodal particle size distribution, wherein a fine fraction [F] comprising crosslinker particles has an average particle size from 1 to 100 nm and a coarse fraction [G] comprising polyurethane-polyurea particles has an average particle size from 10 to 400 nm, and the weight ratio between the fine fraction and the coarse fraction is between 0.5/99.5 and 10/90.

2. An aqueous, self-crosslinking one-component (1K) polyurethane dispersion according to claim 1, wherein the dispersion has a solids content of 40% to 70% by weight, and the viscosity of the dispersion is between 50 and 20000 mPas (23° C.).

3. An aqueous, self-crosslinking one-component (1K) polyurethane dispersion according to claim 1, wherein the crosslinker particles of the fine fraction [F] are hydrophilicized polyisocyanates.

4. An aqueous, self-crosslinking one-component (1K) polyurethane dispersion according to claim 1, wherein the crosslinker particles are prepared by reacting
a) one or more polyisocyanates,
b) 50 to 90 equivalent-%, based on the isocyanate-reactive groups, of a thermally eliminable blocking agent,
c) 10 to 45 equivalent-%, based on the isocyanate-reactive groups, of a hydroxycarboxylic acid as hydrophilicizing agent and
d) 0 to 15 equivalent-% based on the isocyanate-reactive groups, of at least one difunctional chain extender,
the carboxylic acid groups of the hydroxycarboxylic acid being neutralized with a base e) before, during or after the polyurethane polymer is dispersed in water.

5. An aqueous, self-crosslinking one-component (1K) polyurethane dispersion according to claim 1, wherein the polyurethane-polyurea particles of the coarse fraction [G] are polyesterpolyurethanes containing carboxyl and hydroxyl groups.

6. An aqueous, self-crosslinking one-component (1K) polyurethane dispersion according to claim 5, wherein the polyesterpolyurethanes are prepared by:
I) preparing an ionically hydrophilicized prepolymer containing hydroxyl or isocyanate end groups by reacting
i) one or more polyisocyanates (A1) having an NCO functionality of ≧2,
ii) at least one hydroxycarboxylic acid (C′), preferably dimethylolpropionic acid, and
iii) optionally a further polyol component (B1) having a hydroxyl group functionality of ≧2 and a molecular weight Mₙ of 62 to 500 Da, preferably 62 to 400 Da, more preferably 62 to 300 Da,
II) forming a prepolymer by reacting the product of step I) with
iv) one or more polyols (B2) having a hydroxyl group functionality of ≧1,
v) at least one polyol (B3) having an average hydroxyl group functionality of ≧2 and a molecular weight Mₙ of 500 to 5000 Da, preferably 500 to 3000 Da, more preferably 500 to 2000 Da,
vi) one or more thermally eliminable blocking agents (Y), and
vii) optionally one or more polyisocyanates (A1) having an NCO functionality of ≧2, and
III) converting the prepolymer formed in step II) by reaction with
viii) at least one hydroxycarboxylic acid (C″), and
ix) one or more polyisocyanates (A1) having an NCO functionality of ≧2,
into a polyurethane polymer which is free from isocyanate groups but has hydroxyl group functionality and which for at least partial neutralization is mixed with a neutralizing agent (N).

7. A process for preparing the aqueous one-component polyurethane dispersion according to claim 1, comprising dispersing the polyurethane-polyurea particles of the coarse fraction [G] in water and with a dispersion of the fine fraction F], wherein the weight ratio of water and fine-fraction dispersion [F] is between 1/1 and 1/20.

8. A process according to claim 7, wherein the fine-fraction dispersion [F] is added before, during or after the addition of the remaining water.

9. A process according to claim 7, wherein at least 50% of the carboxylic acid groups present in the polyurethane particles (II) are neutralized with suitable neutralizing agents and then dispersed with deionized water, the neutralization to taking place before, during or after the dispersing step.

10. A process according to claim 9, wherein the neutralization takes place before the addition of water.

11. Baking varnishes comprising the aqueous, self-crosslinking one-component (1K) polyurethane dispersions according to claim 1.

12. Materials comprising the aqueous one-component polyurethane dispersion according to claim 1, the materials selected from the groups consisting of inks, paints, sealants or adhesives.
